(19) United States
(12) Patent Application Publication
(10) Pub. No.: US 2023/0350023 A1
(43) Pub. Date: Nov. 2, 2023

(54) HIGH-ACCURACY OPTICAL SENSOR FOR DISTANCE MEASUREMENT AND METHOD FOR MANUFACTURING OPTICAL SENSOR

(71) Applicant: SHUNSIN TECHNOLOGY (ZHONG SHAN) LIMITED, Zhongshan (CN)

(72) Inventor: SHUN-HSING LIAO, Zhongshan City (CN)

(21) Appl. No.: 17/743,158

(22) Filed: May 12, 2022

(30) Foreign Application Priority Data
Apr. 27, 2022 (CN) 202210453400.2

(51) Int. Cl. G01S 7/481; G01S 7/4865

(52) U.S. Cl. CPC G01S 7/4813; G01S 7/4865

(57) ABSTRACT

A more accurate and durable optical sensor employed in time-of-flight distance detection includes a substrate, a cover, a light emitter, and measurement and reference photodetectors. The substrate includes grooves and the cover includes sidewalls having an extension portion. The cover extends into the grooves to connect with the substrate and forms an internal space. The cover has a first light transmitting portion, a second light transmitting portion, and a protrusion extending toward the substrate and dividing the internal space into first and second chambers. The light emitter is arranged on the substrate in the first chamber, the receiving photodetector is disposed on the groove and in the second chamber. The reference photodetector enables precise timing by shielding against internal and unwanted stray light. A method for making the optical sensor is also disclosed.

### FIELD

The subject matter herein generally relates to optical transmissions and sensors.

### BACKGROUND

A time-of-flight (ToF) measurement measures the distance to an object by the time difference between the emission of a light and the return of its reflection from an object.

However, the stability of the bonding between product components of optical sensors is weak, which affects the quality of the product, the smallest degree of misalignment in the light emitter or receiver can compromise the accuracy of measurement. Therefore, there is room for improvement within the art.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic cross-sectional diagram of an optical sensor according to an embodiment of the disclosure;

FIG. 2 is a schematic cross-sectional diagram of a substrate of the optical sensor according to an embodiment of the disclosure;

FIG. 3 is a schematic cross-sectional diagram of a cover of the optical sensor according to an embodiment of the disclosure; and

FIGS. 4A, 4B, 4C, 4D, 4E, 4F and 4G are schematic cross-sectional diagrams illustrating a process flow of a method of manufacturing an optical sensor according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

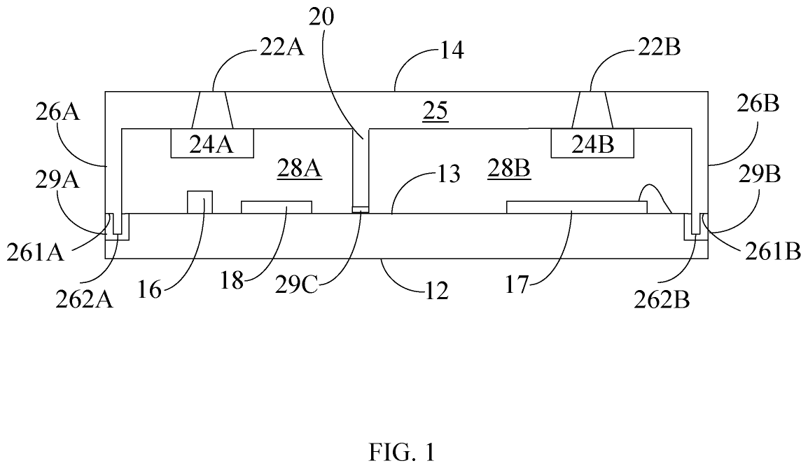

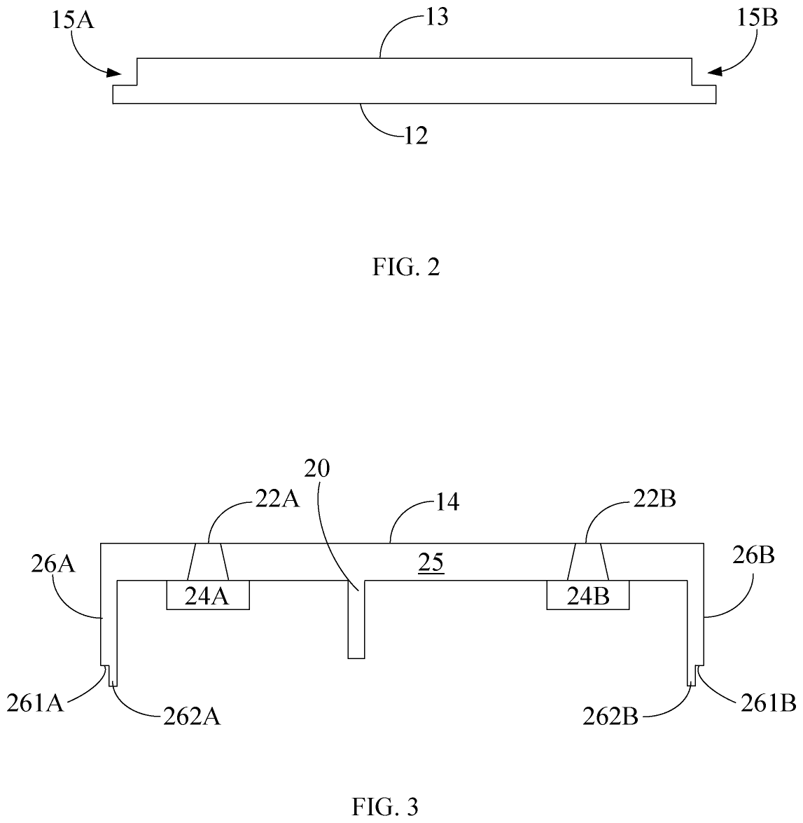

FIG. 1 illustrates an optical sensor according to an embodiment of the disclosure. As shown in FIG. 1, the optical sensor 10 comprises a substrate 12, a cover 14, a light emitter 16, a measurement photodetector 17, and a reference photodetector 18. FIG. 2 illustrates the substrate 12 according to an embodiment of the disclosure. As shown in FIG. 1 and FIG. 2, the substrate 12 has a surface 13, a first groove 15A, and a second groove 15B. The first groove 15A and the second groove 15B are located around the substrate 12 for accommodating the cover 14. In the cross-sectional view shown in FIGS. 1 and 2, the first groove 15A and the second groove 15B are located on both sides of the substrate 12.

The first groove 15A and the second groove 15B can be formed by cutting the substrate 12 using laser. According to an embodiment of the disclosure, the depth of the first groove 15A and the second groove 15B is about half of the thickness of the substrate 12. The substrate 12 can be made of different materials, such as plastic materials, epoxy materials, composite materials, FR-4 materials, or ceramic materials. The substrate 12 has a structure with bonding pads to couple with related electronic components. The related electronic components may include circuit components and control circuits necessary for implementing the functions of transmitting or receiving light signals. The related electronic components are well known to those skilled in the art, and will not be repeated here.

FIG. 3 illustrates the cover 14 according to an embodiment of the disclosure. As shown in FIG. 1 and FIG. 3, the cover 14 is connected to the substrate 12 and forms an internal space with the substrate 12. According to an embodiment, the material of the cover 14 may be an opaque plastic polymer material. The cover 14 comprises a top cover 25 and sidewalls 26A and 26B extending from the periphery of the top cover 25 toward the substrate 12 and accommodated by the first groove 15A and the second groove 15B of the substrate 12. The sidewall 26A has a first bottom 261A facing the first groove 15A and an extension portion 262A extending toward the substrate 12 from the first bottom 261A. Similarly, the sidewall 26B has a second bottom 261B facing the second groove 15B and an extension portion 262B extending from the second bottom surface 261B toward the substrate 12.

The cover 14 further comprises a protrusion 20, a first light transmitting portion 22A, and a second light transmitting portion 22B. The protrusion 20 is located on the surface of the top cover 25 facing the substrate 12 and extending toward the substrate 12. According to the embodiment, the protrusion 20 may be independent elements or can be integrally formed with the top cover 25. The protrusion 20 divides the internal space formed by the cover 14 and the substrate 12 into a first chamber 28A and a second chamber 28B. As shown in FIG. 1, when the cover 14 is combined with the substrate 12, the sidewall 26A extends into the first groove 15A and is connected to the substrate 12 by the adhesive layer 29A, and the sidewall 26B extends into the second groove 15B and is connected to the substrate 12 by the adhesive layer 29B. In addition, the bottom of the extension 262A is located between the bottom of the first groove 15A and the first bottom 261A, and the bottom of the extension 262B is located between the bottom of the second groove 15B and the second bottom 261B. According to an embodiment of the disclosure, by adding an extension portion 262A to the sidewall 26A, the contact surface between the sidewall 26A and the adhesive layer 29A is increased, so that the adhesive layer 29A provides stronger and more stable adhesive force, thereby improving the stability between the cover 14 and the substrate 12.

The light emitter 16 is disposed on the surface 13 of the substrate 12 and is located in the first chamber 28A. In the embodiment of the disclosure, the light emitter 16 can be one or multiple vertical cavity surface emitting laser diodes (hereinafter referred to as VCSELs). The VCSELs form an array to emit light signals. In other embodiments, the light emitter 16 can be light emitting diodes, edge emitting laser diodes (EELD), or distributed feedback lasers (DFB). In an embodiment of the disclosure, the light emitter 16 emits light beams in the infrared waveband. In other embodiments, the light emitter 16 can also emit light in other wavebands such as visible light and ultraviolet light.

According to an embodiment of the disclosure, the optical sensor 10 further comprises a measurement photodetector 17 and a reference photodetector 18. The measurement photodetector 17 is disposed on the surface 13 of the substrate 12 and is located in the second chamber 28B. The reference photodetector 18 is disposed on the surface 13 and is located in the first chamber 28A. The photodetector types constituting the measurement photodetector 17 and reference photodetector 18 may include PN-type photodiodes, PIN-type photodiodes, and avalanche-type photodiodes.

In addition, the first light filter 24A and the second light filter 24B are respectively provided in the first light transmitting portion 22A and the second light transmitting portion 22B. The position of the first light transmitting part 22A corresponds to the light emitter 16, and that of the second light transmitting part 22B corresponds to the measurement photodetector 17. The light emitter 16 emits a light beam according to the control signal issued by the control circuit (not shown in the figures). The emitted light beam passes through the first light filter 24A of the first light transmitting portion 22A towards a target, and reflected light returns to the measurement photodetector 17 through the second light filter 24B of the second light transmitting portion 22B.

The first optical filter 24A and the second optical filter 24B are designed to filter out light which is outside the frequency band emitted by the optical transmitter 16, so that the measurement photodetector 17 can analyze only the pure reflected light. According to another embodiment, a lens may be used instead of the optical filter to control the direction of the emitted light beam, or a lens may be combined with the optical filter to achieve better optical path and light transmission quality.

In addition, according to an embodiment of the disclosure, the substrate 12 and the cover 14 of the optical sensor 10 can be joined adhesively, by adhesive layers 29A and 29B. The protrusion 20 can be joined with the substrate 12 by adhesive layer 29C. Similarly, the light emitter 16, the measurement photodetector 17, and the reference photodetector 18 can also be fixed on the substrate 12 adhesively. According to an embodiment of the disclosure, the adhesive layer can be formed of various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as such materials have the required adhesive properties.

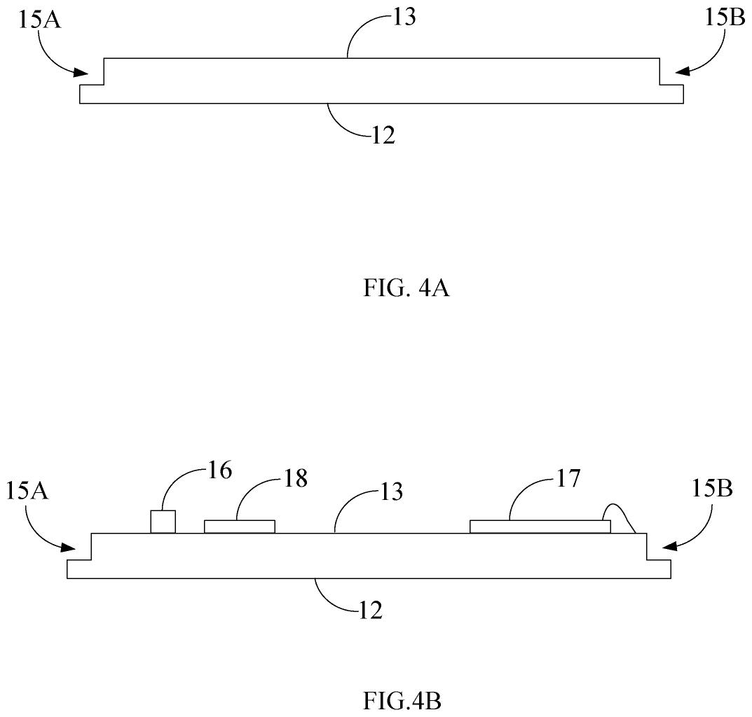

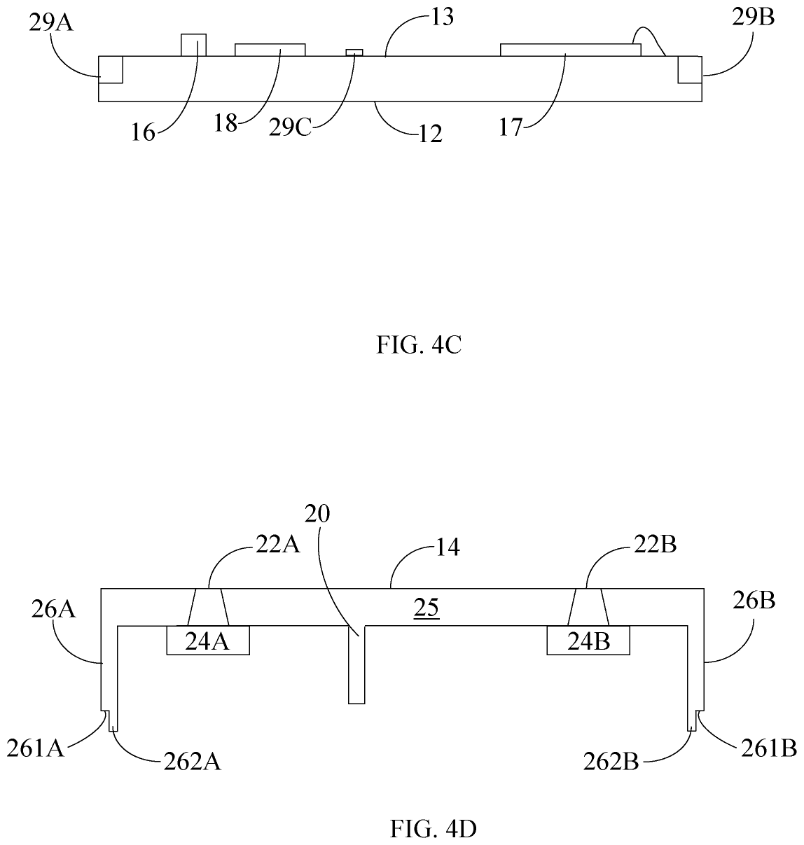

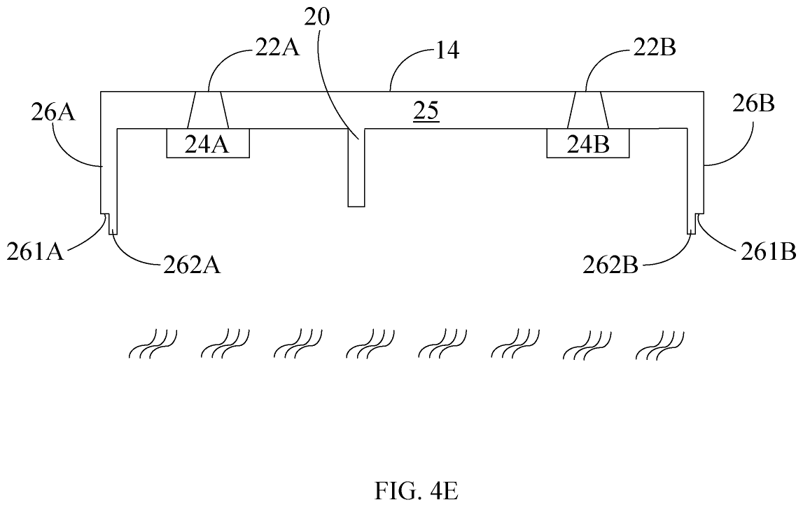

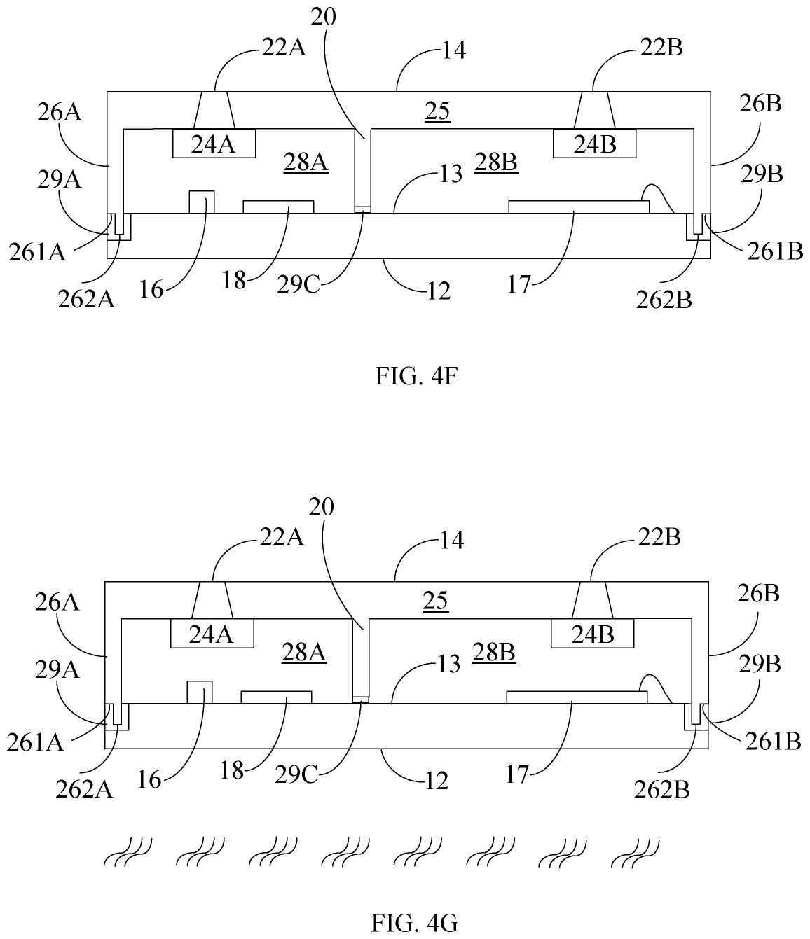

FIGS. 4A-4G illustrate embodiments for implementation of the method of the disclosure. First, referring to FIG. 4A, a substrate 12 is provided. The substrate 12 has a surface 13, a first groove 15A, and a second groove 15B. The first groove 15A and the second groove 15B are located on both sides of the substrate 12, and can be formed by cutting the substrate 12 using laser. According to an embodiment of the disclosure, the depth of the first groove 15A and the second groove 15B is about half of the thickness of the substrate 12. The substrate 12 can be made of different materials, such as plastic materials, epoxy materials, composite materials, FR-4 materials, or ceramic materials. The substrate 12 has a structure providing bonding pads to couple with related electronic components. The related electronic components may include circuit components and control circuits necessary for implementing the functions of transmitting or receiving light signals. The related electronic components are well known to those skilled in the art, and will not be repeated here.

Next, referring to FIG. 4B, the light emitter 16, the measurement photodetector 17, and the reference photodetector 18 can be disposed on the substrate 12. According to an embodiment of the disclosure, components can be attached to the substrate 12 through an adhesive layer, and electrical connections can be made by wire bonding (Wire Bonding), Tape Automated Bonding (TAB), Flip Chip (FC), etc. In an embodiment of the disclosure, the light emitter 16 can be one or multiple vertical cavity surface emitting laser diodes (hereinafter referred to as VCSELs). The VCSELs form an array to emit light as signals. In other embodiments, the light emitter 16 can be surface-emitting laser diodes, light emitting diodes, edge emitting laser diodes (EELD), or distributed feedback lasers (DFB). In an embodiment of the disclosure, the light emitter 16 is used to emit light beams in the infrared waveband. In other embodiments, the light emitter 16 can also emit light in other wavebands such as visible light and ultraviolet light. The types of measurement photodetector 17 and reference photodetector 18 may include PN-type photodiodes, PIN-type photodiodes, and avalanche-type photodiodes.

Next, referring to FIG. 4C, the adhesive layers 29A, 29B, 29C are respectively formed on the first groove 15A, the second groove 15B, and the surface 13 of the substrate 12. According to an embodiment of the disclosure, the adhesive layer can be formed of various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as such materials have the required adhesive properties.

Next, referring to FIG. 4D, a cover 14 is provided, and a first optical filter 24A and a second optical filter 24B are provided on the cover 14. The first optical filter 24A and the second optical filter 24B are respectively disposed on the first light transmitting portion 22A and the second light transmitting portion 22B through adhesive layers. According to an embodiment, the material of the cover 14 may be an opaque plastic polymer material. The cover 14 comprises a top cover 25 and sidewalls 26A and 26B extending from the periphery of the top cover 25 toward the substrate 12 and to be accommodated by the first groove 15A and the second groove 15B of the substrate 12. The sidewall 26A has a first bottom 261A facing the first groove 15A and an extension portion 262A extending toward the substrate 12 from the first bottom 261A. Similarly, the sidewall 26B has a second bottom 261B facing the second groove 15B and an extension portion 262B extending from the second bottom surface 261B toward the substrate 12. The cover 14 further comprises a protrusion 20. The protrusion 20 is located on the surface of the top cover 25 facing the substrate 12 and extends toward the substrate 12. According to the embodiment, the protrusion 20 may be an independent element or can be integrally formed with the top cover 25.

Next, referring to FIG. 4E, the cover 14 with the first light filter 24A and the second light filter 24B are baked or cured to solidify the adhesive layer between the light filters and the cover 14. According to the embodiment of the disclosure, the baking temperature can be controlled to be between 100° C. and 170° C. according to the materials of the first light filter 24A, the second light filter 24B, the cover 14, and the adhesive layer.

Next, referring to FIG. 4F, the cover 14 is connected to the substrate 12 and forms an internal space with the substrate 12. The protrusion 20 divides the internal space into a first chamber 28A and a second chamber 28B. When the cover 14 is combined with the substrate 12, the sidewall 26A extends into the first groove 15A and is connected to the substrate 12 by the adhesive layer 29A, and the sidewall 26B extends into the second groove 15B and is connected to the substrate 12 by the adhesive layer 29B. In addition, the bottom of the extension 262A is located between the bottom of the first groove 15A and the first bottom 261A, and the bottom of the extension 262B is located between the bottom of the second groove 15B and the second bottom 261B. According to other embodiments of the disclosure, the protrusion 20 of the cover 14 may be at a substantial distance from the surface 13 of the substrate 12, so that the first chamber 28A and the second chamber 28B can communicate with each other. Since there is no physical contact between the protrusion 20 and the surface 13 of the substrate 12, the old manufacturing process of connecting the protrusion 20 with the surface 13 of the substrate 12 is eliminated. This not only simplifies the manufacturing process, but also saves the cost of the adhesive layer. Furthermore, glue overflow or the risk of glue overflow when the adhesive layer is squeezed between the protrusion 20 and the surface 13 of the substrate 12 is avoided. Next, referring to FIG. 4Q the combined cover 14 and the substrate 12 are baked or cured to solidify the adhesive layer between the cover 14 and the substrate 12. According to the embodiment of the disclosure, the baking temperature can be controlled to be between 100° C. and 170° C. according to the materials of the substrate 12, the cover 14, and the adhesive layer.

According to an embodiment of the disclosure, referring to FIG. 1, when the optical sensor performs distance measurement, the light emitter 16 located in the first chamber 28A emits a light beam according to the control signal issued by the control circuit (not shown in the figures). The reference photodetector 18 in the first chamber 28A detects the emitted light beam and generates a reference signal, this being at a first time t1. The emitted light beam emitted by the light emitter 16 is emitted out through the first light filter 24A of the first light transmitting portion 22A. After being reflected by a target (not shown in the figures), the reflected light beam is transmitted into the second chamber 28B through the second light filter 24B of the second light-transmitting portion 22B. At this time, the measuring photodetector 17 in the second chamber 28B detects the reflected light beam and generates a measurement signal at a second time t2. Next, the reference signal and measurement signal are transmitted to the control circuit. Since the reference signal and the measurement signal are respectively generated at the first time t1 and the second time t2, the control circuit can obtain the precise flight time of the light beam (t2-t1) according to the reference signal and the measurement signal. The distance d between the optical sensor and the target to be measured can be obtained by calculating 50% of the product of the flight time (t2-t1) and the speed of light C, thus

(d=C*(t2−t1)/2).

The distance measurement system using the optical sensors according to the embodiments of the disclosure can be applied to a variety of devices, such as smart phones, portable computers, smart watches, tablet computers, game devices, televisions, personal computers, internal communication systems, home automation systems, automotive security systems, 3D imaging systems, gesture control systems, touch sensors, fingerprint sensors, diagnostic systems, interactive displays, 3D sensing systems, household appliances, robot vacuum cleaners, display devices, iris recognition systems, etc.

According to the embodiments of the disclosure, by adding an extension portion on the sidewall, the contact surface between the sidewall and the adhesive layer is increased, so that the adhesive layer can provide a more solid and extensive adhesive force, thereby improving the stability between the cover and the substrate. Furthermore, since the adhesive layer can provide higher adhesive force, the thickness of the sidewall can be reduced, which reduces the volume of the optical sensor, and improves the product yield.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical sensor comprising:
a substrate comprising a surface and a first groove;
a cover extending into the first groove to connect with the substrate and forming an internal space with the substrate, wherein the cover comprises a protrusion, a first light transmitting portion, and a second light transmitting portion, the protrusion extends toward the substrate and contacting with the surface by a first adhesive layer, and divides the internal space into a first chamber and a second chamber;
a light emitter disposed on the surface of the substrate in the first chamber; and
a measurement photodetector disposed on the surface in the second chamber.

2. The optical sensor of claim 1, wherein the first light transmitting portion is correspondingly positioned relative to the light emitter, and the second light transmitting portion is correspondingly positioned relative to the measurement photodetector.

3. The optical sensor of claim 1, wherein the cover comprises a top cover and sidewalls extending from a periphery of the top cover toward the substrate, the sidewalls are connected to the substrate, the sidewalls comprise a first sidewall extending into the first groove and connected to the substrate by a second adhesive layer, and the first protrusion extends toward the substrate from the top cover.

4. The optical sensor of claim 3, wherein the first sidewall comprises a first bottom facing the first groove, and a first extension portion extending from the first bottom toward the substrate.

5. The optical sensor of claim 4, wherein the substrate further comprises a second groove, the sidewalls comprise a second sidewall extending into the second groove and connected to the substrate by a third adhesive layer.

6. The optical sensor of claim 5, wherein the second sidewall comprises a second bottom facing the second groove, and a second extension portion extending from the second bottom toward the substrate.

7. The optical sensor of claim 6, wherein a bottom of the first extension portion is between a bottom of the first groove and the first bottom, and a bottom of the second extension portion is between a bottom of the second groove and the second bottom.

8. The optical sensor of claim 1, wherein the light emitter emits a detection light beam according to a control signal provided by a control circuit, the first light transmitting portion is positioned to transmit the detection light beam towards a target, then a reflected light beam is reflected by the target, the second light transmitting portion is positioned to transmit the reflected light beam to the measurement photodetector, the measurement photodetector generates a measurement signal according to the reflected light beam, and the control circuit obtains a flight time according to the measurement signal.

9. The optical sensor of claim 1, further comprising a reference photodetector disposed in the first chamber and a control circuit configured for providing a control signal, wherein the light emitter emits a detection light beam according to the control signal, the first light transmitting portion is positioned to transmit the detection light beam towards a target, then a reflected light beam is reflected by the target, the second light transmitting portion is positioned to transmit the reflected light beam to the measurement photodetector, the measurement photodetector generates a measurement signal according to the reflected light beam, the reference photodetector generates a reference signal according to the detection light beam, and the control circuit obtains a flight time according to the measurement signal and the reference signal.

10. The optical sensor of claim 1, further comprising a first light filter and a second light filter respectively disposed on the first light transmitting portion and the second light transmitting portion.

11. A method of manufacturing an optical sensor comprising:
providing a substrate comprising a surface and a first groove;
providing a cover comprising a protrusion, a first light transmitting portion, and a second light transmitting portion;
connecting the substrate with the cover at the first groove and forming an internal space by the substrate and the cover, wherein the protrusion extends toward the substrate and contacts with the surface by a first adhesive layer, and divides the internal space into a first chamber and a second chamber;
disposing a light emitter on the surface of the substrate in the first chamber; and
disposing a measurement photodetector on the surface in the second chamber.

12. The method of claim 11, wherein the first light transmitting portion is correspondingly positioned relative to the light emitter, and the second light transmitting portion is correspondingly positioned relative to the measurement photodetector

13. The method of claim 11, wherein the cover comprises a top cover and sidewalls extending from a periphery of the top cover toward the substrate, the sidewalls are connected to the substrate, the sidewalls comprise a first sidewall extending into the first groove and connected to the substrate by a second adhesive layer, and the first protrusion extends toward the substrate from the top cover.

14. The method of claim 13, wherein the first sidewall comprises a first bottom facing the first groove, and a first extension portion extending from the first bottom toward the substrate.

15. The method of claim 14, wherein the substrate further comprises a second groove, the sidewalls comprise a second sidewall extending into the second groove and connected to the substrate by a third adhesive layer.

16. The method of claim 15, wherein the second sidewall comprises a second bottom facing the second groove, and a second extension portion extending from the second bottom toward the substrate.

17. The method of claim 16, wherein a bottom of the first extension portion is between a bottom of the first groove and the first bottom, and a bottom of the second extension portion is between a bottom of the second groove and the second bottom.

18. The method of claim 11, further comprising providing a first light filter and a second light filter respectively disposed on the first light transmitting portion and the second light transmitting portion.
